(19) United States
(12) Patent Application Publication
(10) Pub. No.: US 2014/0098007 A1
(43) Pub. Date: Apr. 10, 2014

(54) SMART WINDOW AND DISPLAY ENCLOSURE

(71) Applicants: Michael Delpier, Houston, TX (US); Dustin L. Hoffman, Cypress, TX (US)

(72) Inventors: Michael Delpier, Houston, TX (US); Dustin L. Hoffman, Cypress, TX (US)

(21) Appl. No.: 14/118,290

(22) PCT Filed: Jun. 30, 2011
(86) PCT No.: PCT/US11/42558

§ 371 Date: Nov. 18, 2013

(51) Int. Cl. G06F 3/14

(52) U.S. Cl. CPC G06F 3/1423
USPC 345/2.1

(57) ABSTRACT

A computing device includes a display enclosure. The display enclosure can include a smart window. In one implementation the smart window is adjusted to indicate a status.

### BACKGROUND

A portable computer such as a notebook has a display and a base. The back of the display of a notebook computer may have a logo representing the manufacturer or a design may be on the back of the notebook to make the notebook more appealing. If the back of the display includes a logo, then the logo may be illuminated.

### BRIEF DESCRIPTION OF THE DRAWINGS

Some embodiments of the invention are described with respect to the following figures:

FIG. 1A-1B are block diagrams of portable computing device according to an example implementation;

FIG. 2A-2D are portable computing devices according to an example implementation;

FIG. 3A-3E are portable computing devices according to an example implementation;

FIG. 4A-4B are cross sections of a computing device according to an example implementation;

FIG. 5 is a flow diagram of a method of indicating a status on a portable computing device comprising according to an example implementation;

FIG. 6 is a flow diagram of a method of indicating a status on a portable computing device comprising according to an example implementation; and

FIG. 7 is a computing system including a computer readable medium according to an example implementation.

### DETAILED DESCRIPTION

Device manufactures may put images on the back of their device. A device may be a portable computing device such as a notebook computer, tablet computer, phone, personal digital assistant or another portable computing device. The images may include a logo for example identifying the device manufacture. In one example the image is illuminated from behind the image by a light source such as the back side of a backlight of a display while the front side of the backlight illuminates the display. The display may be for example a liquid crystal display (LCD), or organic light emitting diode display to display graphics generated by a video controller. When the light source is off the image is still visible but is not illuminated. The image does not change from the perspective of the user other than being illuminated or not illuminated.

If the illumination for the image is from the backlight of a display the light source may not be adjusted because it would change the graphics on the display generated by the video controller. If a smart window is used the light through a portion of an image on the portable device opposite the display can be controlled independent of the light source.

A smart window may be used to allow or prevent light from illuminating an image. A smart window can be any electrically switchable window that changes light transmission properties when voltage is applied. For example if voltage is applied such that the current flows in a first direction the window becomes opaque and if the voltage is applied such that the current flows in a second direction the window becomes translucent or transparent. For the purpose of the example implementations the smart window may be transparent if it allows substantially all the light to pass through the smart window and may be opaque if it substantially blocks all light from passing through the smart window.

In one example electricity may be applied for changing the opacity of the smart window, but once the change has been effected, no electricity is applied for maintaining the particular shade which has been reached. By not continuously applying power to the smart window power is saved while still allowing control of an image opposite the display. A smart window may be adjusted based on a status of the computer wherein an image visible on the smart window may indicate the status such as orientation, battery capacity, power state or another status.

In one example, a portable computing device can include a display enclosure. A display can be on a first side of the display enclosure. A smart window can be on a second side opposite to the first side of the display enclosure. A controller can control the smart window based a status of the portable computer system.

In another example, a portable computing device can include a display enclosure. A display can be on a first side of the display enclosure. A first smart window can be on a second side opposite the first side of the display enclosure. A second smart window can also be on the second side opposite the first side. At least a portion of the first smart window and the second smart window do not overlap. A portion of the first smart window may not overlap with the second smart window so that the light to illuminate a portion of the image is controlled by a single smart window.

In another example, a portable computing device may monitor the status of a portable computing device using a controller. The status can be compared to a first threshold. Based on the first threshold the opacity of the smart window in a display enclosure can be adjusted to allow light to pass through.

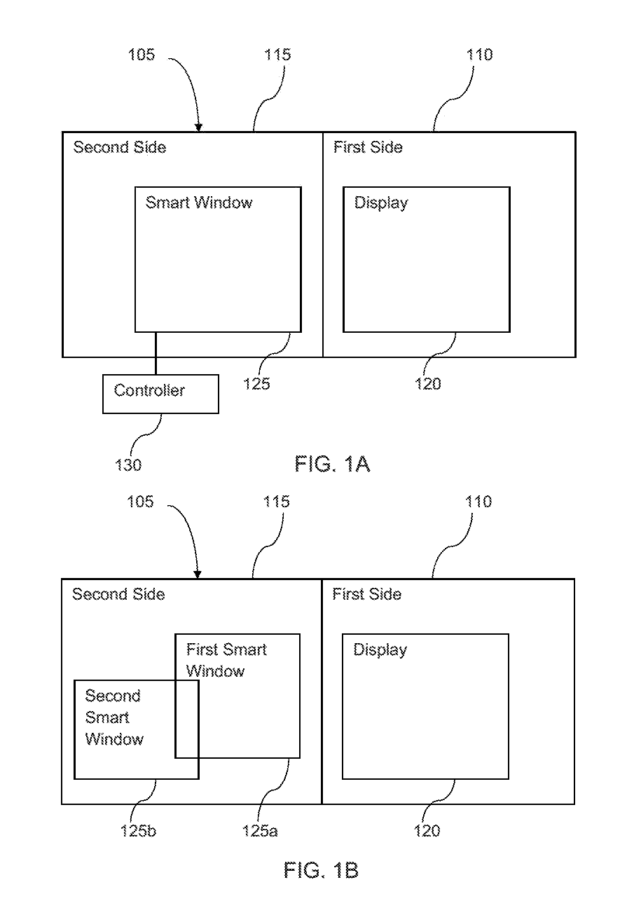

With reference to the figures, FIG. 1A is a block diagram of portable computing device according to an example implementation. The portable computing device can include a display enclosure 105. The first side 110 of the display enclosure 105 can include a display 120.

The display 120 may be for example a liquid crystal display (LCD). The LCD may include a backlight to illuminate the display. A smart window 125 can be on a second side 115 of the display enclosure 105 opposite to the first side 110 of the display enclosure 105. A controller 130 can control the smart window based a status of the portable computer system.

FIG. 1B is a block diagram of portable computing device according to an example implementation. The portable computing device can includes a display enclosure 105. A display 120 can be on a first side 110 of the display enclosure 105. A first smart window 125a can be on a second side 115 of the display enclosure 115 opposite the first side 110 of the display enclosure 105. A second smart window 125b can be on the second side 115 of the display enclosure 105 opposite the first side 110 of the display enclosure 105. In one example at least a portion of the first smart window 125a and the second smart window 125b do not overlap.

A smart window may be for example, electrochromic devices, suspended particle devices, Micro-Blinds or voltage controlled window opacity controller. An electrochromic device changes light transmission properties in response to voltage and allows control over the amount of light and heat passing through. In an electrochromic smart window, the electrochromic material changes its opacity. Electricity is applied for changing its opacity, but once the change has been effected, no electricity is applied for maintaining the particular shade which has been reached.

In suspended particle devices (SPDs), a thin film laminate of rod-like particles suspended in a fluid is placed between two layers, or attached to one layer. If no voltage is applied to the particles, the suspended particles are arranged in random orientations and absorb light, so that the glass panels are opaque. If voltage is applied, the suspended particles align and let light pass through the smart window.

Micro-blinds control the amount of light passing through in response to applied voltage. The micro-blinds are composed of rolled thin metal blinds on glass. If no applied voltage is applied, the micro-blinds are rolled and let light pass through. When there is a voltage between the rolled metal layer and the transparent conductive layer, the electric field formed between the two electrodes causes the rolled micro-blinds to stretch out and block light.

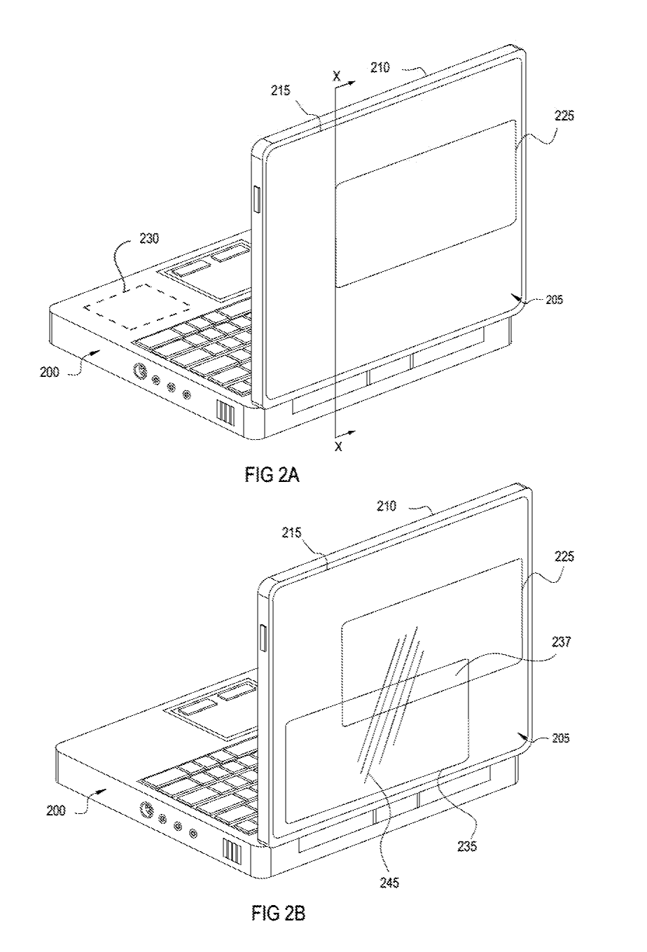

FIGS. 2A-2D are portable computing devices according to an example implementation. FIG. 2A is a portable computing device 200. The portable computing device can include a smart window 225 on the second side 215 of display enclosure 205. The second side 215 of the display enclosure can be opposite the display on the first side 210 of the display enclosure 205. A controller 230 can be included in the portable computing device 200 to adjust the opacity of the smart window 225 by controlling a voltage to the smart window 225. The controller 230 may monitor at least one of orientation, battery capacity, communication, power state, or any other status of the portable computing device 200. A communication may be for example the number of emails that are unread. A battery capacity may include the remaining run time or another indication of battery capacity. A power state may be for example an operating state, sleep, suspend, or hibernation state. An orientation may indicate whether the display is in landscape or portrait view.

Although there is a line outlining the smart window this is for description purposes and the area of the smart window 225 may be indistinguishable when opaque from the non-smart window areas of the second side of the display enclosure 205.

FIGS. 2B-2D are an example of a portable computing device that includes multiple smart windows. FIG. 2B is a portable computing device 200 including a first smart window 225 and a second smart window 235. The first smart window 225 and the second smart window 235 are on a second side 215 of the display enclosure 205 opposite the first side 210. The first smart window 225 and the second smart window 235 have an overlapping area 237. In an example implementation overlapping smart windows may allow different levels of opacity to be achieved_by adjusting the opacity of each of the smart windows independently. In other examples the multiple smart windows may be aligned such that they entirely overlap or may not be aligned such that at least a portion of one of the smart windows does not overlap with another of the smart windows. A smart window may cover the whole second side 215 of the display enclosure 205 or may cover any portion less than the whole of the display enclosure. If a smart window is in a transparent state light can pass through illuminating an image 245 on the second side 215 of the display enclosure 205.

In the example of FIG. 2B the smart window 225 and the smart window 235 are in the transparent state. In the example of FIG. 2C the smart window 225 is in a transparent state and the smart window 235 is in an opaque state. In the example of FIG. 2D the smart window 225 is in an opaque state and the smart window 235 is in a transparent state.

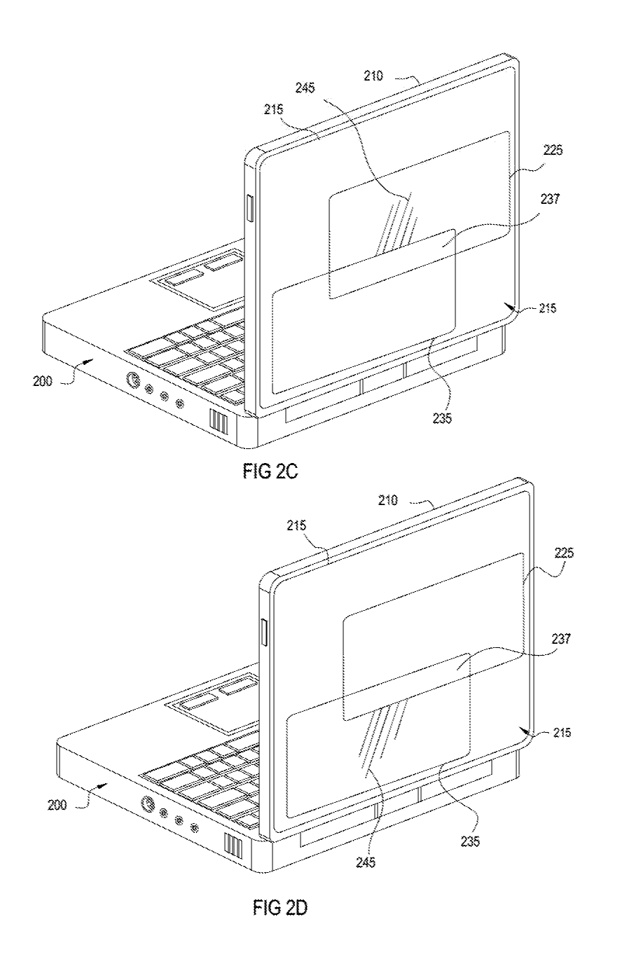

FIGS. 3A-3E are portable computing devices according to an example implementation. FIG. 3A-3E are a display enclosure 340 showing different states of the multiple smart windows 325a, 325b, and 325c. The smart window areas 325a, 325b, and 325c are indicated by a dotted line for illustration purposes and the edge of the smart window may not be distinguishable to a user. In FIG. 3A the smart windows 325a, 325b and 325c are all in a transparent state and are allowing light to pass through making the images 345a, 345b, 345c visible. The image may be for example a logo for the manufacturer.

In FIG. 3B the smart windows 325a, 325b and 325c are all in an opaque state. In the example the display enclosure appears to be continuous and the opaque smart windows are indistinguishable from the areas of the display enclosure that do not include a smart window.

In FIG. 3C the smart window 325b is transparent while the smart windows 325a and 325c are opaque such that the image 345b is visible while the images 345a and 345c are hidden by the opaque smart windows. In FIG. 3D the smart window 325a is transparent while the smart windows 325b and 325c are opaque such that the image 345a is visible while the images 345b and 345c are hidden by the opaque smart windows. In FIG. 3E the smart window 325c is transparent while the smart windows 325a and 325b are opaque such that the image 345c is visible while the images 345a and 345b are hidden by the opaque smart windows. If the status is for example the orientation of the portable computing device. The controller can adjust a logo for example so that the logo is readable to the user. The orientation may be determined for example by an accelerometer of the portable computing device.

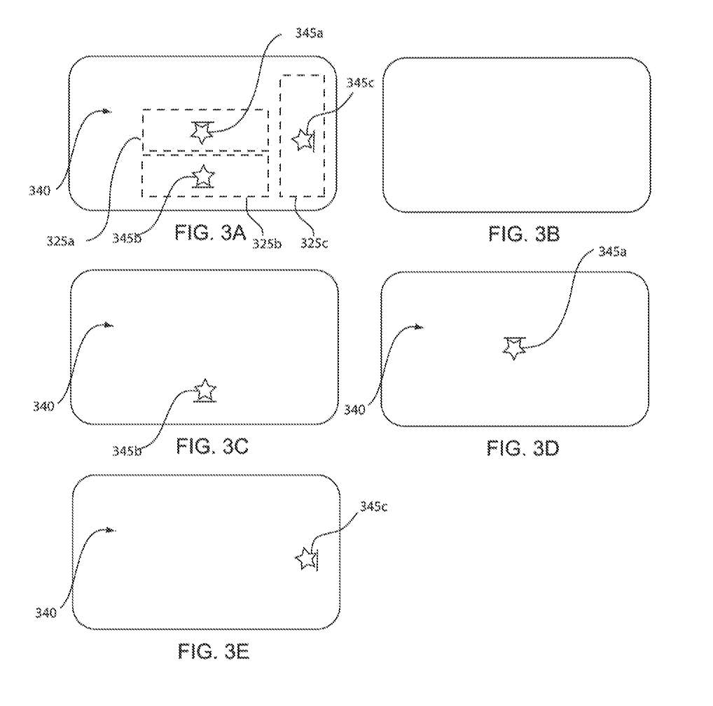

FIG. 4A-4B are example cross sections as indicated at X in FIG. 2A of a computing device according to an example implementation. The computing device can include a display enclosure 405. The display enclosure 405 can includes a first side 410 and a second side 415. The first side 410 can include a display 465 such as an LCD display. The display 465 may include a light source 460. The light source may be a backlight including a light guide to distribute light from a cold cathode florescent light (CCFL) or light emitting diode (LED) source.

The second side 415 of the display enclosure 405 may include an opaque area 450 that prevents a user from seeing through the opaque area. The opaque area can be created by a coating on the material such as a paint or may be pigment in the material. In one example the second side has a transparent area 455. The smart window 425 may be aligned with the transparent area 455. An image layer 445 can be adjacent to the smart window 425. If the light source is on the light can illuminate the image from behind. The image layer 445 may be a display that is controlled by a video controller or may be a coating such as paint or ink. If the smart window is transparent then the image is visible on the second side 415 of the display enclosure 405. If the smart window is opaque the image is not visible on the second side 415 of the display enclosure 405. In the example of FIG. 4B the transparent area 455 is not used and in its place is the smart window 425. The image 445 may be coating such as ink or paint applied to the smart window 425 for example. In some examples ink for the image may be activated by heat from the light source 460 or by light from the light source 460. The light source may be the backlight of the display 465, it may also be a separate light source or a reflective surface to reflect light from outside the display enclosure though the image. The image may also be reflective itself.

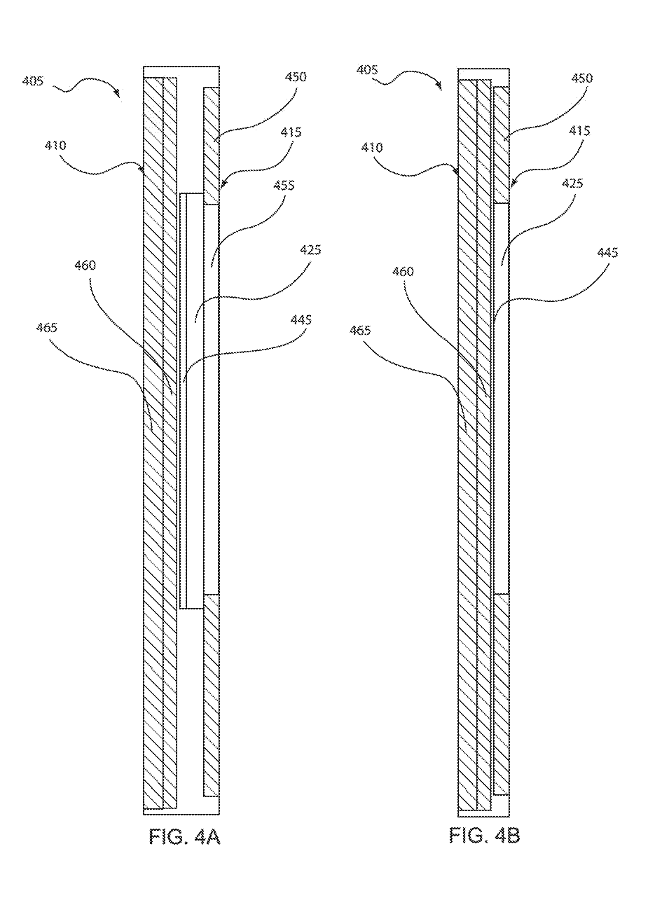

FIG. 5 is a flow diagram of a method of indicating a status on a portable computing device comprising according to an example implementation. The method monitors the status by a controller at 505. The controller may be the controller 130 of FIG. 1a-1b. The controller can compare the status to a first threshold at 510. The threshold may be for example a battery capacity such as 70%, a count of the total unread emails such as 30 emails or another threshold of a monitored status. The opacity of a smart window in a display enclosure of a portable computing device can be adjusted to allow light to pass through at 515. Adjusting the opacity of the smart window can be by applying power to the smart window.

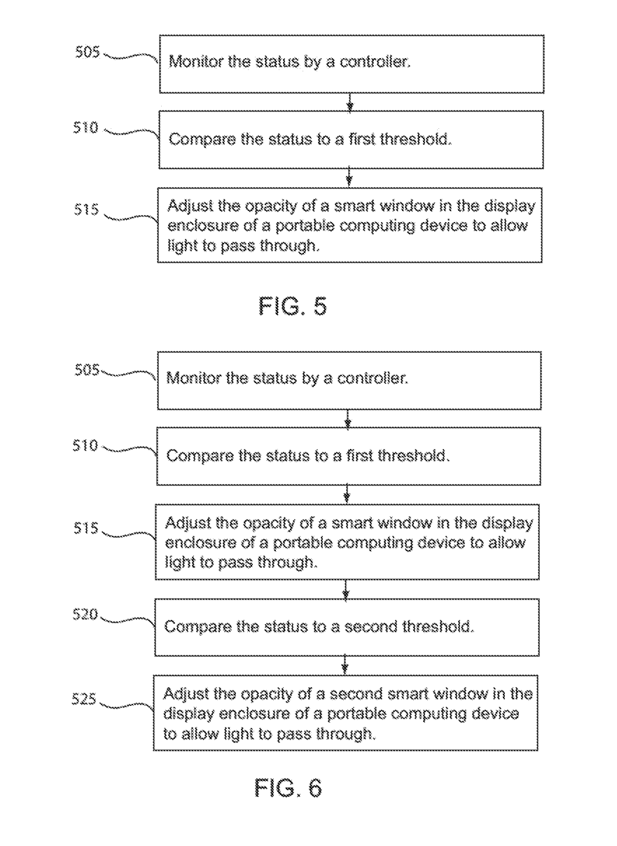

FIG. 6 is a flow diagram of a method of indicating a status on a portable computing device comprising according to an example implementation FIG. 5 is a flow diagram of a method of indicating a status on a portable computing device comprising according to an example implementation. The method monitors the status by a controller at 505. The controller may be the controller 130 of FIG. 1a-1b. The controller can compare the status to a first threshold at 510. The opacity of a smart window in a display enclosure of a portable computing device can be adjusted to allow light to pass through at 515. Adjusting the opacity of the smart window can be by applying power to the smart window. In one example a second threshold is used to adjust a second smart window on the portable computing device to allow light to pass through. In one example the amount of power or the length of time that power is applied to the smart window can change the opacity of the smart window. If the amount of light transmission is based on the amount of time that voltage is applied to the smart window, then an example may be the smart window is 100% non-light transmissive after a voltage is applied for 1 second or the 50% light transmissive after a voltage is applied for 0.5 second.

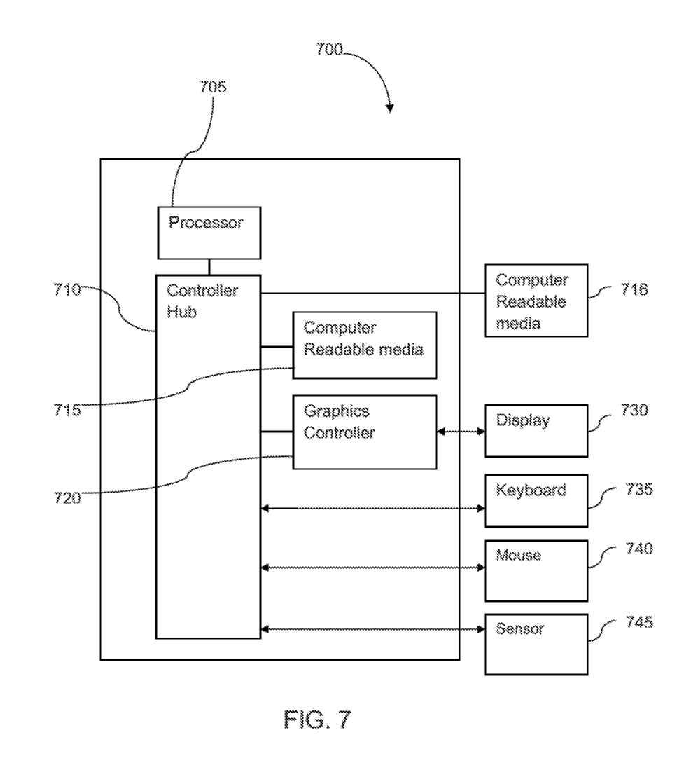

FIG. 7 is a computing device including a computer readable medium according to an example implementation. The computing device 700 can include a processor 705. The processor can be connected to a controller hub 710. The controller hub 710 can be connected to internal computer readable media 715 or external computer readable media 716. The controller hub may also be connected to the image controller 720 that controls the images on a display 730. The controller hub 710 may be connected to input/out devices such as a keyboard 735, mouse 740, or sensor 745.

The techniques described above may be embodied in a computer-readable medium for configuring a computing system to execute the method. The computer readable media may include, for example and without limitation, any number of the following; magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc,; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A portable computing device comprising:
a display enclosure;
a display on a first side of the display enclosure;
a smart window on a second side opposite the first side; and
a controller to control the smart window based a status of the portable computer system.

2. The device of claim 1, further comprising a second smart window.

3. The device of claim 1, wherein the smart window is a portion of the second side that is less than the whole of the second side.

4. The device of claim 1, further comprising a light source to illuminate the image.

5. The device of claim 1, wherein the controller is to monitor at least one of orientation, battery capacity, communication, and power states.

6. The device of claim 1, further comprising a layer, adjacent to the smart window including an image.

7. The device of claim 1, wherein the smart window changes opacity if voltage is applied and maintains the opacity without voltage being applied.

8. A method of indicating a status on a portable computing device comprising:
monitoring the status by a controller;
comparing the status to a first threshold;
adjusting in opacity of a smart window in a display enclosure of a portable computing device to allow light to pass through.

9. The method of claim 8, further comprising comparing the status to a second threshold and adjusting a second smart window on the portable computing device to allow light to pass through.

10. The method of claim 8, further comprising applying power to the smart window to adjust the smart window, wherein the smart window maintains the opacity if power is not being applied.

11. A portable computing device comprising:
a display enclosure;
a display on a first side of the enclosure;
a first smart window on a second side opposite the first side;
a second smart window on the second side opposite the first side, wherein at least a portion of the first smart window and the second smart window do not overlap.

12. The device of claim 11, further comprising a controller to control the first smart window and the second smart window based on status of the portable computer system.

13. The device of claim 11, wherein the smart window changes opacity if voltage is applied and maintains the opacity without voltage being applied.

14. The device of claim 11, further comprising a layer including an image, wherein the layer adjacent to at least one of the first smart window and the second smart window.

15. The device of claim 14, wherein the image is not visible if the smart window is in an opaque state and the image is visible if the smart window is in a transparent state.
